(19) United States
(12) Patent Application Publication
(10) Pub. No.: US 2008/0099687 A1
(43) Pub. Date: May 1, 2008

(54) RADIATION IMAGE DETECTOR

(75) Inventors: Takehiko Shoji, Tokyo (JP); Mitsuru Sekiguchi, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 11/875,064

(22) Filed: Oct. 19, 2007

(30) Foreign Application Priority Data
Oct. 25, 2006 (JP) JP2006-289687

(51) Int. Cl. G01T 1/20

(52) U.S. Cl. 250/368

(57) ABSTRACT

A radiation image detector comprising: a scintillator panel comprising a substrate having thereon a phosphor layer; a protective cover provided on a side of the substrate opposite the phosphor layer, wherein a radiation is incident on the side of the substrate opposite the phosphor layer; a light receiving element provided on a side of the scintillator panel opposite the protective cover, the light receiving element having a plurality of two-dimensionally arrayed light receiving pixels which photoelectrically convert light generated by the scintillator panel, wherein distance D satisfies: 0.2 mm≦D≦2.0 mm wherein D is a distance between following (i) and (ii): (i) a surface of the protective cover facing the scintillator panel; and (ii) a surface of the substrate on which the phosphor layer is provided.

This application is based on Japanese Patent Application No. 2006-289687 filed on Oct. 25, 2006 in Japanese Patent Office, the entire content of which is hereby incorporated by reference.

### FIELD OF THE INVENTION

The present invention relates to a radiation image detector.

### BACKGROUND OF THE INVENTION

The radiation image (also referred to as the radiation image) represented by an X-ray image has been widely used to diagnose the state of disease in the medical field. In recent years, a digital radiation image detector as represented by a flat panel type radiographic detector (flat panel detector) has appeared on the market. It is capable of acquiring a radiation image as digital information, processing an image and achieving instantaneous transmission of image information.

The FPD employs a scintillator panel that, in response to the radiation having passed through a subject, provides instantaneous emission of fluorescent light at an intensity corresponding to the dose thereof. The light emitting efficiency of the scintillator panel increases as the thickness of the phosphor layer increases. However, when the phosphor layer is too thick, scattered light will be produced inside the phosphore layer, with the result that sharpness of the image is reduced. To enhance the diagnostic performance, an image of enhanced sharpness is desired.

When using a phosphor of columnar crystal structure such as cesium iodide (CsI), generation of scattered light inside the crystal is reduced by the light guide effect. This makes it possible to increase the thickness of the phosphor layer and to enhance light emitting efficiency while maintaining a high degree of sharpness. Further, when thallium (Tl) as an activator is added to cesium iodide (CsI), the light emitting efficiency can be improved (e.g., refer to Patent Document 1).

It is a common practice to provide on the radiation incoming side of the scintillator panel a protective cover for protecting the scintillator panel against external shock. The protective cover is made of a highly radiotransparent material, however, the radiation is not a little scattered by the protective cover resulting in reducing the degree of sharpness of the radiation image.

Patent Document 1 Unexamined Japanese Patent Application Publication (hereafter referred to as JP-A) No. 2002-116258

### SUMMARY OF THE INVENTION

An object of the present invention is to provide a radiation image detector capable of producing a radiation image of a high degree of sharpness by optimizing the distance from the protective cover to the scintillator panel.

One of the aspects to achieve the above object of the present invention is a radiation image detector comprising:

a scintillator panel comprising a substrate having thereon a phosphor layer;

a protective cover provided on a side of the substrate opposite the phosphor layer, wherein a radiation is incident on the side of the substrate opposite the phosphor layer;

a light receiving element provided on a side of the scintillator panel opposite the protective cover, the light receiving element having a plurality of two-dimensionally arrayed light receiving pixels which photoelectrically convert light generated by the scintillator panel,

wherein

distance D satisfies:

0.2 mm≦D≦2.0 mm.

wherein
D is a distance between following (i) and (ii):

(i) a surface of the protective cover facing the scintillator panel; and

(ii) a surface of the substrate on which the phosphor layer is provided.

### BRIEF DESCRIPTION OF THE DRAWINGS

FIG. 1 is a schematic diagram illustrating the radiation image detector of the present embodiment.

FIG. 2 is a schematic diagram representing the vacuum evaporation apparatus used to form a scintillator layer.

### DESCRIPTION OF THE PREFERRED EMBODIMENTS

The above object of the present invention is achieved by the following structures.
(1) A Radiation Image Detector Comprising:

a scintillator panel comprising a substrate having thereon a phosphor layer;

a protective cover provided on a side of the substrate opposite the phosphor layer, wherein a radiation is incident on the side of the substrate opposite the phosphor layer;

a light receiving element provided on a side of the scintillator panel opposite the protective cover, the light receiving element having a plurality of two-dimensionally arrayed light receiving pixels which photoelectrically convert light generated by the scintillator panel,

wherein

distance D satisfies:

0.2 mm≦D≦2.0 mm.

wherein
D is a Distance between Following (i) and (ii):

(i) a surface of the protective cover facing the scintillator panel; and

(ii) a surface of the substrate on which the phosphor layer is provided.
(2) The radiation image detector of Item (1), wherein the substrate is a polymer film having a thickness of 50 μm to 500 μm.
(3) The radiation image detector of Item (1) or (2), wherein a cushioning material is provided between (i) and (ii),

wherein the cushioning material comprises a foamed material containing silicon or a foamed material containing urethane.
(4) The radiation image detector of any one of Items (1) to (3), wherein the protective cover comprises aluminum or carbon.

It was found in the present invention that, as the distance from the protective cover to the scintillator panel is increased, the sharpness of the radiographic image deteriorated so that the reduction in the degree of sharpness cannot be ignored, and that, by optimizing the distance D from the protective cover to the scintillator panel, a radiographic image having a high degree of sharpness can be obtained despite the radiation may be scattered by the protective cover.

The radiation image detector of the present invention includes:

a scintillator panel having a substrate on which a phosphor layer is formed;

a protective cover provided on the radiation incoming side of the scintillator panel on the side of the substrate opposite the phosphor layer;

a light receiving element provided on a side of the scintillator panel opposite the protective cover, the light receiving element having a plurality of two-dimensionally arrayed light receiving pixels which photoelectrically convert light generated by the scintillator panel, distance D satisfies:

0.2 mm≦D≦2.0 mm.

wherein
D is a distance between following (i) and (ii):

(i) a surface of the protective cover facing the scintillator panel; and

(ii) a surface of the substrate on which the phosphor layer is provided.

According to the present invention, even when the radiation is scattered by a protective cover, the radiation enters the scintillator panel before the scattered light is much dispersed, whereby a radiation image having a high degree of sharpness is obtained.

Referring to the attached drawing, the following describes an example of the present embodiment, however, the present invention is not limited thereto.

### (Structure of Radiation Image Detector)

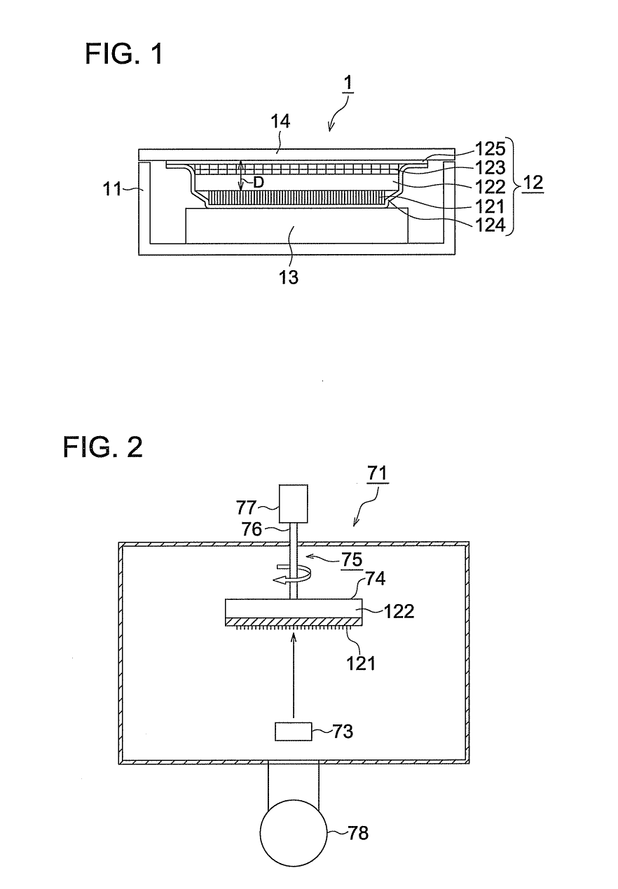

FIG. 1 is a schematic diagram representing the radiation image detector 1 of the present embodiment. The radiation image detector 1 is included inside the enclosure 11:

a scintillator panel 12 which, in response to the radiation having passed through a subject, provides instantaneous emission of fluorescent light at an intensity corresponding to the dose thereof; and

a light receiving element 13 on which a plurality of light receiving pixels are arranged in a two-dimensional array, the light receiving pixels being arranged in contact with the scintillator panel 12 and designed to photoelectrically convert the light from the scintillator panel 12.

The scintillator panel 12 is structured in such a way that a cushioning layer 123 is arranged on the rear surface of the substrate 122 opposite the phosphor layer 121, and the substrate 122 and cushioning layer 123 are sealed by the first protective film 124 and second protective film 125.

The substrate 122 is made from the material that allows transmission of radiation. The substrate 122 is preferably flexible enough to ensure uniform contact of the scintillator panel 12 onto the surface of the light receiving element 13. For example, a 125 μm-thick flexible polyimide film can be used. In addition to the polyimide film, it is possible to use a cellulose acetate film, polyester film, polyethylene terephthalate film, polyethylene naphthalate film, polyamide film, triacetate film and polycarbonate film. The preferred thickness is 50 through 500 μm.

The phosphor layer 121 is made of the phosphor layer of columnar crystal structure characterized by light guiding performance and a high degree of light emitting efficiency. For example, when the cesium iodide (CsI) with thallium (Tl) added thereto as an activator is subjected to vacuum evaporation as a phosphor material, a phosphor layer of columnar crystal structure can be formed on the substrate 122. In addition to cesium iodide (CsI), cesium bromide (CsBr) can be used. In addition to thallium (Tl), europium, indium, lithium, potassium, rubidium, sodium, copper, cerium, zinc, titanium, gadolinium and terbium can be utilized as an activator.

The cushioning layer 123 is used to press the scintillator panel 12 against the light receiving element 13 at an adequate pressure. For example, a silicon or urethane foam material of less X-ray absorption can be utilized.

The first protective film 124 and second protective film 125 protect the phosphor layer 121 against moisture and reduce deterioration of the phosphor layer 121. It is made of a film of low moisture permeability. For example, a polyethylene terephthalate film (PET) can be employed. In addition to the PET, a polyester film, polymethacrylate film, nitrocellulose film, cellulose acetate film, polypropylene film and polyethylene naphthalate film can be utilized.

Further, a fusion-bonding layer for mutual fusion-bonding and sealing is formed on the mutually opposing surfaces of the first protective film 124 and second protective film 125. For example, a casting polypropylene (CPP) layer) is formed. A cushioning layer 123 is arranged on the surface of the substrate 122 opposite the phosphor layer 121. The substrate 122 and cushioning layer 123 are sandwiched between the first protective film 124 and second protective film 125. The edges wherein the first protective film 124 and second protective film 125 are brought in contact are fusion-bonded under a reduced pressure, whereby sealing is completed.

The light receiving element 13 contains a plurality of light receiving pixels arranged in a two-dimensional array. For example, it can be fabricated using a photodiode and a thin film transistor (TFT) in combination. The signal charge having been subjected to photoelectric conversion by the photodiode is read out using the TFT. For example, CMOS and CCD can be used for the light receiving element 13.

The protective cover 14 protects the scintillator panel 12 against the external shock and impact, and compresses the cushioning layer 123 so that the scintillator panel 12 is pressed against the light receiving element 13 at an adequate pressure. For example, it is made up of a high radiotransparent carbon plate. Further, an aluminum plate can also be used as the protective cover 14. (Distance D from the surface of the protective cover facing the scintillator panel to the surface of the substrate on which the phosphor layer is provided)

FIG. 1 shows the distance D from the surface of the protective cover 14 facing the scintillator panel 12 to the surface of the substrate 122 on which the phosphor layer 121 is provided). As described above, radiation is not a little scattered by the protective cover 14, and the sharpness of the radiation image is degraded. This degradation in sharpness cannot be ignored if the distance from the protective cover 14 to the scintillator panel is excessively long.

Accordingly, in the present embodiment, the distance D is adjusted within the range of 0.2 mm≦D≦2.0 mm. This adjustment ensures that, despite the radiation being scattered in a protective cover, the radiation enters the scintillator panel 12 before the scattered light is much dispersed, whereby a radiation image of a high degree of sharpness is obtained. If the distance D is greater than 2.0 mm, the radiation enters the scintillator panel 12 with a greater dispersion of scattered light, whereby the sharpness of a radiation image is degraded. The smaller the distance D is, the higher the degree of sharpness becomes. Basically, there is no restriction to the lower limit. However, a substrate 122 and cushioning layer 123 are present in the area from the surface of the protective cover 14 facing the scintillator panel 12, to the surface of the substrate on which the phosphor layer is formed. Thus, it is virtually difficult to make the distance D smaller than 0.2 mm. If the cushioning layer 123 is not provided, the distance D can be made smaller than 0.2 mm. However, absence of the cushioning layer 123 makes it difficult to press the scintillator panel 12 against the light receiving element 13 at an adequate pressure. This deteriorates the degree of contact between the scintillator panel 12 and light receiving element 13, with the result that the degree of sharpness is reduced.

As described above, to minimize the distance D, a thin polymer film having a thickness of 50 through 500 μm is preferably utilized as the substrate 122. Further, use of a thin polymer film increases flexibility and ensures uniform contact of the scintillator panel 12 onto the surface of the light receiving element 13, with the result that the degree of sharpness is enhanced. In this respect, use of a thin polymer film is advantageous. If the thickness is greater than 500 μm, the distance including the cushioning layer 123 cannot be kept less than 2.0 mm. If the thickness is smaller than 50 μm, the handling of the film will be troublesome when the scintillator panel 12 is manufactured.

To minimize the distance D, the thickness of the cushioning layer 123 is preferably minimized as well. However, if the thickness is too small, a cushioning effect will be reduced. Thus, a thin layer having a cushioning effect is preferably utilized. A cushioning material made of a silicon or urethane based foaming agent is preferably used because it has a cushioning effect even if it is thin, and absorbs less radiation.

To reduce the scattered light of the radiation in the protective cover 14, a radiotransparent cover made up of the material including aluminum or carbon is preferably employed as the protective cover 14.

In the present embodiment, the cushioning layer 123 is arranged inside the scintillator panel 12 sealed by the first protective film 124 and the second protective film 125. It can be arranged between the second protective film 125 and protective cover 14 outside the second protective film 125.

### EXAMPLES

The following describes the details of the present invention with reference to Examples, however, the present invention is not limited thereto.

### (Preparation of a Substrate)

A 75 μm-thick polyimide film (UPILEX-75S by Ube Industries, Ltd.) provided with plasma treatment to enhance the adhesiveness of the phosphor is used as a vacuum evaporation substrate 122.

### (Preparation of Phosphor Sheet)

Using the vacuum evaporation apparatus 71 of FIG. 2, a phosphor (CsI: 0.003Tl) was vacuum evaporated on the prepared substrate 122, and a phosphor layer 121 was formed, whereby a phosphor sheet was prepared.

To be more specific, the phosphor material (CsI: 0.003Tl) was filled in a resistance heating crucible 73, and the aforementioned substrate 122 was installed on the substrate holder 74, wherein the distance between the resistance heating crucible 73 and substrate 122 was adjusted to 400 mm. This was followed by the step of evacuating the vacuum evaporation apparatus once, and introducing argon gas thereafter, so that the degree of vacuum was 0.5 Pa. After that, while the substrate 122 was rotated at 10 rpm by the rotation member 75, the temperature of the substrate 122 was kept at 150° C. Then the resistance heating crucible 73 was heated so that the phosphor was vapor deposited. When the film thickness of the phosphor layer 121 reached 500 μm, vacuum evaporation was terminated. In FIG. 2, 76 represents a shaft and 77 represents a motor.

### (Sealing Phosphor Sheet by Protective Film)

A 12 μm-thick PET (polyethylene terephthalate film) and 20 μm-thick CPP (casting polypropylene) lamination film were used as the protective film 124 on the phosphor layer side. The lamination film was laminated via a dry lamination method and the thickness of the adhesive layer was 1 μm. A two-part reactive urethane adhesive was used as the adhesive. The protective film 125 used on the substrate side was the same film as the protective film 124 on the phosphor surface side.

The aforementioned protective films 124 and 125 were arranged above and below the phosphor sheet (9 cm×9 cm). The edge portion was fusion-bonded under reduced pressure using an impulse sealer, whereby sealing was completed. Fusion-bonding was carried out so that the distance from the fusion-bonded portion to the phosphor sheet edge portion was 1 mm. The heater of the impulse sealer used for fusion-bonding was 8 mm wide.

In this case, an urethane based foamed sheet was installed between the substrate of the scintillator panel 122 and the second protective film 125, wherein the thickness of this urethane based foamed sheet was adjusted so that the distance: from (i) the surface of the protective cover 14 facing the scintillator panel to (ii) the surface of the substrate on which the phosphor layer is provided, would meet the value shown in Table 1.

### (Evaluation)

Each sample having been obtained was set on the CMOS flat panel (X-ray CMOS camera system Shad-o-Box4 KEV by Rad Icon Co., Ltd.), and the sharpness was evaluated based on the 12-bit output data according to the following procedure: The result is shown in Table 1. A cover made of amorphous carbon (1 mm) was used as the protective cover 14.

### <Evaluation of Sharpness by Contrast (C) Value>

A lead disk having a diameter of 4 mm and a thickness of 2 mm was placed on the protective cover 14. The contrast (C) value was calculated based on the image data obtained by imaging this lead disk on the aforementioned CMOS flat panel. The signal S1 of the lead disk center and the average signal S2 at the position 10 through 20 mm away from the lead disk center were read and the contrast value (C) was calculated according to the following calculation formula (A), whereby evaluation was performed. A smaller contrast value (C) means that the sharpness of the image is more enhanced.

C(%)=S1/S2×100 (A)

To ensure uniform application of the X-ray having a tube voltage of 80 kVp to the phosphor sheet (9 cm×9 cm) alone, the aperature of the X-ray tube was adjusted for photographing.

TABLE 1

| | D (mm) | | | | | | | |
|---|---|---|---|---|---|---|---|---|
| | 0.11 mm | | | | | | | |
| | (Without | | | | | | | |
| | foamed | | | | | | | |
| | sheet) | 0.20 mm | 0.5 mm | 1.0 mm | 2.0 mm | 2.5 mm | 3.0 mm | 4.0 mm |
| C | 1.5 | 0.6 | 0.7 | 0.7 | 0.8 | 4.0 | 5.2 | 6.0 |
| (%) | | | | | | | | |

D: Distance from the surface of the protective cover on the scintillator panel side to the surface of the substrate wherein a phosphor layer is formed
C: Contrast value (%)

Table 1 demonstrates that, if D is kept in the range of 0.2 mm≦D≦2.0 mm, the contrast value (C) is small and the degrees of sharpness is excellent.

What is claimed is:

1. A radiation image detector comprising:
a scintillator panel comprising a substrate having thereon a phosphor layer;
a protective cover provided on a side of the substrate opposite the phosphor layer, wherein a radiation is incident on the side of the substrate opposite the phosphor layer;
a light receiving element provided on a side of the scintillator panel opposite the protective cover, the light receiving element having a plurality of two-dimensionally arrayed light receiving pixels which photoelectrically convert light generated by the scintillator panel,
wherein
distance D satisfies:
0.2 mm≦D≦2.0 mm.
wherein
D is a distance between following (i) and (ii):
(i) a surface of the protective cover facing the scintillator panel; and
(ii) a surface of the substrate on which the phosphor layer is provided.

2. The radiation image detector of claim 1, wherein the substrate is a polymer film having a thickness of 50 μm to 500 μm.

3. The radiation image detector of claim 1, wherein a cushioning material is provided between (i) and (ii),
wherein the cushioning material comprises a foamed material containing silicon or a foamed material containing urethane.

4. The radiation image detector of claim 1, wherein the protective cover comprises aluminum or carbon.
